(19) United States
(12) Patent Application Publication
(10) Pub. No.: US 2023/0017398 A1
(43) Pub. Date: Jan. 19, 2023

(54) CONTEXTUALLY AWARE CUSTOMER ITEM ENTRY FOR AUTONOMOUS SHOPPING APPLICATIONS

(71) Applicant: Grabango Co., Berkeley, CA (US)

(72) Inventors: William Glaser, Berkeley, CA (US); Brian Van Osdol, Piedmont, CA (US)

(21) Appl. No.: 17/592,386

(22) Filed: Feb. 3, 2022

Related U.S. Application Data
(63) Continuation of application No. 15/900,511, filed on Feb. 20, 2018, now abandoned.
(60) Provisional application No. 62/461,050, filed on Feb. 20, 2017.
(60) Provisional application No. 62/572,819, filed on Oct. 16, 2017.

(51) Int. Cl. G06Q 30/06; G06Q 20/20; G07G 1/00; G07G 3/00; G06V 20/20; G06V 20/52; G06V 20/64

(52) U.S. Cl. CPC G06Q 30/0633; G06Q 20/203; G06Q 30/0639; G07G 1/0081; G07G 3/00; G06V 20/20; G06V 20/52; G06V 20/64

(57) ABSTRACT

A system and method for contextually aware customer item entry for autonomous shopping applications that includes an environmental sensing system distributed through a shopping environment that is configured to collect contextual data of customer activity in the environment; the environmental sensing system comprising at least a computer vision monitoring system, the computer vision monitoring system comprising a set of imaging devices distributed through the environment; a customer-managed item entry system that is movable through the environment by the customer and that is configured to collect item selection input; a virtual cart management module configured to manage a virtual cart with the item selection input and augmented at least in part by the contextual data, wherein the virtual cart is used in execution of an autonomous checkout process.

### CROSS-REFERENCE TO RELATED APPLICATIONS

This application is a Continuation Application which claims the benefit of U.S. patent application Ser. No. 15/900,511, filed on 20 Feb. 2018, which claims the benefit of U.S. Provisional Application No. 62/461,050, filed on 20 Feb. 2017, and U.S. Provisional Application No. 62/572,819, filed on 16 Oct. 2017, all of which are incorporated in their entireties by this reference.

### TECHNICAL FIELD

This invention relates generally to the field of self-checkout devices, and more specifically to a new and useful system and method for contextually aware customer item entry for autonomous shopping applications.

### BACKGROUND

In some stores, self-checkout kiosks allow customers to scan items and checkout. However, lines will often form for self-checkout kiosks and the process can be slow, error prone, and cumbersome. Various solutions have been proposed in the past including computerized shopping carts that often act like a movable self-checkout kiosk with barcode scanners. These have not seen success in the market for a number of reasons. In many cases, the solution imports the usability problems of the stationary self-checkout kiosks, and the computerized shopping carts can be cost prohibitive. Thus, there is a need in the self-checkout device field to create a new and useful system and method for a system and method for contextually aware customer item entry for autonomous shopping applications. This invention provides such a new and useful system and method.

### BRIEF DESCRIPTION OF THE FIGURES

FIG. 1 is a schematic representation of a system of a preferred embodiment;

FIG. 2 is a schematic representation of a variation of the system with a customer application item entry system;

FIG. 3 is a schematic representation of a variation of the system with smart glasses item entry system;

FIGS. 4 and 5 are schematic representations of variations of the system with smart cart item entry systems;

FIG. 6 is an exemplary schematic representation of a manual item entry mechanism on a customer application;

FIG. 7 is an exemplary schematic representation of a manual item entry mechanism using a sensor of a computing device;

FIG. 8 is a schematic representation of a smart cart item entry system;

FIG. 9 is a schematic representation of a variation of a cart attachment fixture;

FIGS. 10A-10C are schematic representations of exemplary CV-based inspection system configurations;

FIG. 11 is a flowchart representation of a method of a preferred embodiment;

FIG. 12 is an exemplary schematic representation of augmenting detection of a selection event;

FIG. 13 is an exemplary schematic representation of augmenting identification of an item;

FIG. 14 is an exemplary schematic representation of augmenting management of the virtual cart through a secondary virtual cart;

FIG. 15 is an exemplary schematic representation of augmenting assessment of the virtual cart; and

FIG. 16 is a flowchart representation of a variation of a method of a preferred embodiment.

### DESCRIPTION OF THE EMBODIMENTS

The following description of the embodiments of the invention is not intended to limit the invention to these embodiments but rather to enable a person skilled in the art to make and use this invention.

### 1. Overview

A system and method for contextually aware customer item entry for autonomous shopping applications of a preferred embodiment, functions to use at least one customer-facing mechanism of item entry and at least one supplementary detection system to collaboratively monitor shopping activity. In particular, the system and method are used in tracking a virtual cart for one or more customers shopping in a shopping environment. The virtual cart can be used in automatic checkout processing. The virtual cart may alternatively facilitate other aspects of the checkout process, used for analytics monitoring, or any suitable application. A virtual cart is preferably a data representation of items selected for purchase and associated with a tracked agent (e.g., a customer, a cart, a bag, etc.).

The system and method preferably utilize one or more contextual data inputs to supplement the identification and validation process used when managing a virtual cart of a smart cart or other form of customer-managed device. In one implementation, a customer may utilize a user-facing application or device to manually enter items for purchase, and the resulting checkout list can be verified and/or validated through a supplemental environmental sensing system. In another variation, a customer can use a customer held or worn device that facilitates automatic sensing of item selection from sensors on the device, and the supplemental environmental sensing system can similarly be used to augment detection, identify items, verify item selection, and/or validate the generated virtual cart. In another implementation, a smart cart can apply the system and method to generate a data representation of selected items as items are added to a physical cart or collected by a user. The supplemental environmental sensing system can augment, enhance, and/or validate use of the smart cart in a similar fashion to management of the customer-facing application.

As one potential advantage, the identification process may be improved by using contextual information relating to the location of the shopper, alternative item identification processes, the history of the shopper, history of other shoppers, contents of the cart, and/or other factors to augment the product identification process, product selection process, or other detection processes involved in managing a virtual cart. The system and method can preferably leverage such capabilities to offer a computer vision (CV) based monitoring system that may rely on minimal action by a customer to add an item to a virtual cart. In some cases, the system and method may enable a customer using a smart cart or smart glasses to avoid an explicit scanning action for each item, and instead items can be accounted for as a customer naturally adds them to a smart cart.

As another potential advantage, the virtual cart generated through the smart cart can be compared, checked, and/or based on a predicted virtual cart generated through remote sensing such as a CV-based monitoring system or an item tagging system.

As one aspect, when a store deploys the use of customer-managed item entry like an app or smart cart, a large amount of trust is put in customers. A store could then afford more trust in customer behavior when allowing use of the item entry system, because the contextual data can provide validation of good or proper behavior and be used to detect illicit or adversarial use of a customer application (e.g., if a customer does not enter some item). As a result, another potential benefit can be enhanced security and reduction in store shrinkage/theft.

As another potential advantage, the system and method can enable a number of potential checks and redundancies so that intentional or unintentional interference with the operation of the customer managed item entry can be detected, corrected, and/or otherwise addressed. Multiple vectors of item identification, including ones implemented by the smart cart and optionally remotely implemented approaches, can be made more robust to user interference.

As another potential benefit, the system and method of some variations can make automatic checkout experiences more feasible for a wide variety of shopping environments. The system and method can operate with lower sensing resolution in environmental sensing systems (e.g., gaps in contextual data and/or fewer sensing capabilities), which may make the system and method less expensive and easier to install.

The system and method are preferably used in a shopping environment serving a diverse set of customers selecting items on display. The shopping environment can include stores such as grocery stores, convenience stores, micro-commerce & unstaffed stores, bulk-item stores, pharmacies, bookstores, warehouses, malls, markets, and/or any suitable environment that promotes commerce or exchange of goods or services. Herein, the user subjects are primarily referred to as customers, and the environment and interactions are described as they relate to a shopping environment. The system and method are not limited to a shopping environment. The user subject may be any suitable type of user. The system and method may alternatively be used in environments that want to account for the removal of an item by an entity such as in a library, a rental store, a warehouse, or any suitable item storage facility.

Herein, automatic checkout is primarily characterized by a system or method that generates or maintains a virtual cart (i.e., a checkout list) during the shopping process with the objective of knowing the possessed or selected items for billing. The checkout process can occur when a customer is in the process of leaving a store. The checkout process could alternatively occur when any suitable condition for completing a checkout process is satisfied such as when a customer selects a checkout option within an application. In performing an automatic checkout process, the system and method can automatically charge an account of a customer for the total of a shopping cart and/or alternatively automatically present the total transaction for customer completion. Actual execution of a transaction may occur during or after the checkout process in the store. For example, a credit card may be billed after the customer leaves the store. In another form of automatic checkout, the virtual cart may be synchronized with a checkout station at the time of checkout, alleviating the worker or customer from entering the items.

A virtual cart is characterized as a record of items selected by or for a customer. The virtual cart is preferably a substantially real-time record, but may alternatively be updated at least in part asynchronous to interactions of a customer (e.g., placing of item in a cart). The items in the virtual cart are preferably product identifiers used in setting a purchase total for a financial transaction during a checkout process. The items may alternatively be credited to a user-account during the checkout process for alternative use cases such as an item rental use case. In the case that a payment mechanism is not linked to an identified customer associated with current use of the item entry system, then a virtual cart may be communicated to a checkout processing station to receive payment from the customer. In some alternative implementations, a customer may enter payment information through the item entry system.

An environment as used herein characterizes the site where the system is installed and operational. The system and method can be made to work for a wide variety of environments. In a preferred implementation, the environment is a shopping environment such as a grocery store, convenience store, micro-commerce & unstaffed store, bulk-item store, pharmacy, bookstore, warehouse, mall, market, and/or any suitable environment that promotes commerce or exchange of goods or services. An environment is generally the inside of a building but may additionally or alternatively include outdoor space and/or multiple locations. In alternate use cases, the environment can include a household, an office setting, a school, an airport, a public/city space, and/or any suitable location. The environment can be a locally contained environment but may alternatively be a distributed system with wide coverage.

### 2. System

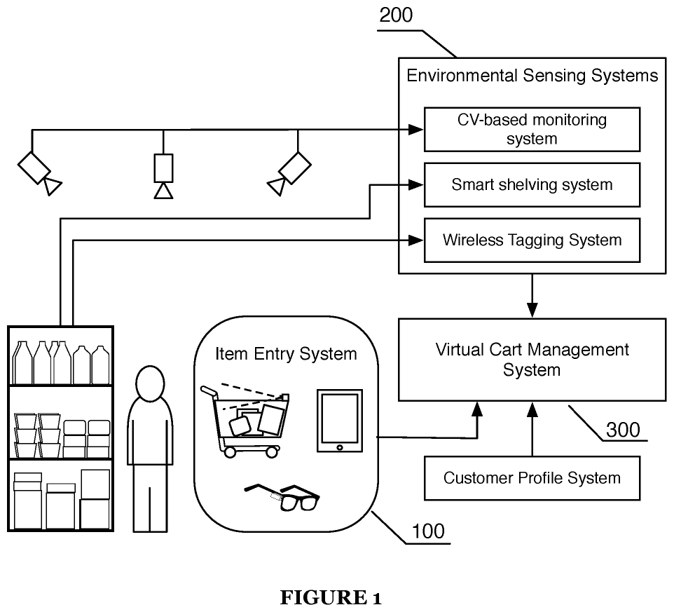

As shown in FIG. 1, a system for a contextually aware customer item entry for autonomous shopping applications of a preferred embodiment can include a customer-managed item entry system 100, an environmental sensing system 200 distributed through an environment, and a virtual cart management system 300. The customer-managed item entry system (IES) 100 is preferably movable through the environment by a customer and collects item entry data used by the virtual cart management system 100 for managing a virtual cart for a customer. Preferably, each customer will use an IES 100 for at least the duration of the shopping experience and data collected from the IES is preferably used as a primary input for managing the virtual cart. The environmental sensing system 200 preferably provides contextual state to the virtual cart management system 300, which is used to augment or supplement the analysis of data from the IES 100. More preferably, the environmental sensing system 200 is a computer vision monitoring system 210. The computer vision monitoring system 210 and/or other alternative monitoring systems may provide location-based context information, behavioral context information, and/or other suitable contextual data to the virtual cart management system. In one variation, the computer vision monitoring system 210 may provide at least a partial model predicting virtual cart contents.

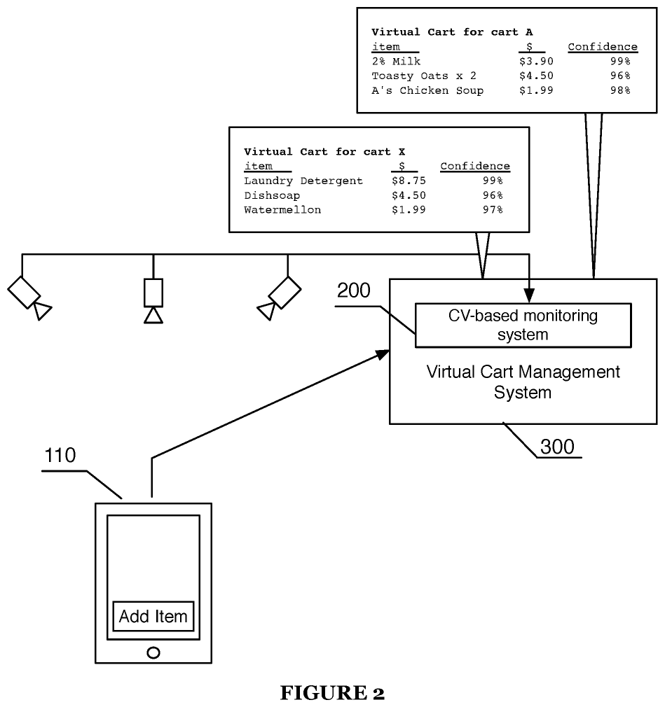

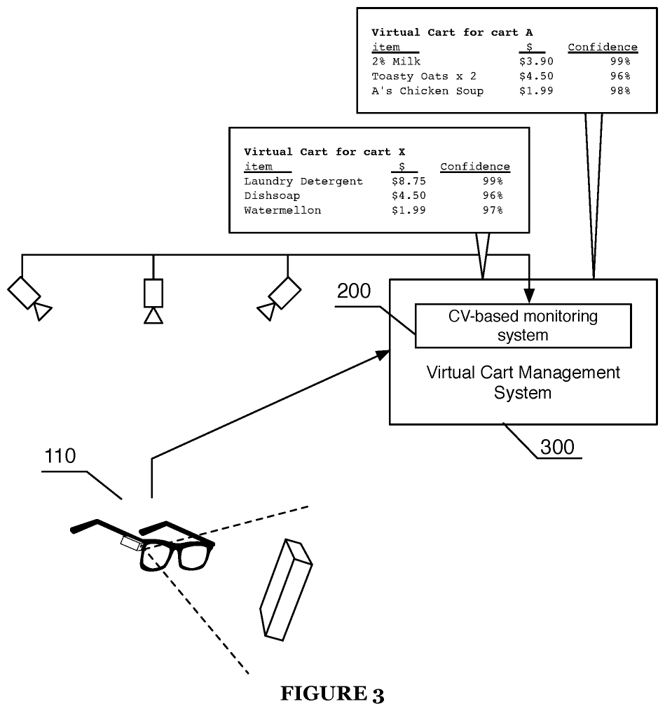

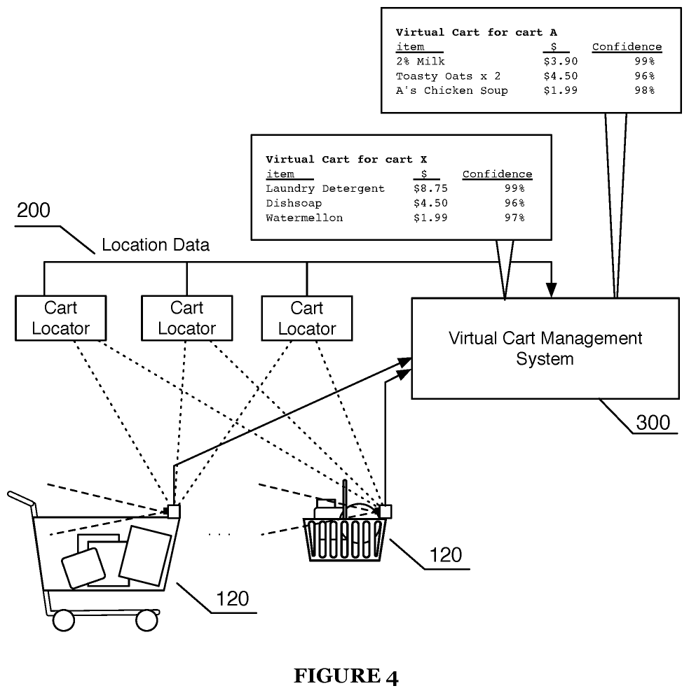

As shown in FIGS. 2 and 3, the system may be used in combination with a customer application. In one implementation, a customer application IES 11o enables manual entry of items by a customer as shown in FIG. 2. In another implementation, the customer application IES 110 is a service operable on a wearable computing device like a pair of smart glasses that facilitates automatic sensing and detection of item selection through sensors of the computing devices as shown in FIG. 3. In another implementation, the system may be used to enable a smart cart IES 120, which may use a computer vision based inspection system for detection of item selection as shown in FIGS. 4 and 5. A customer wishing to perform automatic checkout could select a smart cart IES 120, and then the smart cart IES 120 would facilitate the generation of a virtual cart so that an automatic checkout transaction could be executed.

### Item Entry System

The customer-managed item entry system 100 of a preferred embodiment functions to act as a primary tool for adding and/or removing items of a virtual cart. The customer-managed IES 100, herein referred more concisely as an IES 100, preferably accompanies a customer during the customer's shopping experience. In other words, the IES 100 is preferably usable through the environment by the customer. In some variations, the IES is movable through the environment such as in the variations where the IES 100 is a smart cart, item scanning device, or a customer application. A movable IES 100 will generally accompany the customer through the environment. For example, a customer will carry or push a smart cart through the environment. However, the IES 100 may alternatively be a set of distributed kiosks such that a customer can use a set of kiosks to enter items as they move about the environment.

The IES 100 preferably includes at least one item entry mechanism configured to collect item selection data. Item selection data preferably includes detecting selection of an item for purchase and/or identification of an item (e.g., a product identifier). The item entry mechanism could be a manual entry mechanism such as a user interface for entering items, a user controlled item scanner (e.g., a barcode reader, a CV-based product identifying tool, etc.). The item entry mechanism could alternatively be an automatic sensing system such as a computer vision system that uses image data collected from the IES 100.

The item entry mechanism of the IES can function as a primary mechanism for generating or managing a virtual cart, but contextual data from an environmental sensing system 200 is preferably used to augment the generation or evaluation of the virtual cart. In one variation, the contextual data may be used to improve the accuracy or performance of detecting item selection. Additionally or alternatively, the contextual data may be used to assess the validity of the virtual cart. For example, the environmental sensing system 200 may be able to provide high level detection of behavior indicating that a customer forgot to enter an item or that the IES 100 may have mis-identified or not detected an item selected by a customer.

The IES 100 can additionally include a user interface, which can function to provide user feedback and/or accept user input. A feedback interface element could be used to deliver feedback around the state of a virtual cart. Preferably, a feedback interface element is configured to deliver feedback in response to the change in virtual cart or the lack of change in virtual cart (e.g., if it was expected based on contextual information). A feedback interface element could be a display, a visual interface element (e.g., an LED light), an audio interface, tactile feedback, and/or any suitable type of feedback interface.

The user input interface may be used to enable customer management of a virtual cart. A user interface offered through the IES 100 may enable a customer to edit a virtual cart or correct an issue detected with the virtual cart. For example, an unidentifiable product detected as being selected may be marked and signaled as an error in the virtual cart, and the customer could correct the error by identifying the product.

The IES 100 will additionally include a communication module, a processor, a power supply, and/or other suitable computing components. The IES 100 will preferably wirelessly communicate with the virtual cart management system 300 or some other suitable computing device to interface with the other components of the system.

A variety of types of item entry systems (IESs) 100 may be used with the system. Two preferred variations of an IES 100 can include a customer application IES 110 and a smart cart IES 120.

In some variations, the IES 100 is operable on a computing device of the customer. A customer provided computing device could facilitate an automatic checkout experience where the store environment can provide little in-store infrastructure. The IES 100 may alternatively be operable on a store-provided computing device. An alternative type of IES 100 could include a barcode scanner provided by the store that can be used by customer to manually enter items during their shopping experience. Another type of IES 100 could be a set of self-checkout kiosks distributed within the shopping environment that a customer could periodically use during the shopping trip so that items are incrementally added to a virtual cart rather than doing a single bulk entry of items in a designated checkout region.

A customer application IES 11o of a preferred embodiment functions to provide implementation wherein an application instance operable on a computing device may be used as customer-managed system for collecting data on items of a virtual cart.

The customer application IES 110 can be operable on a smart phone, a smart watch, a tablet, smart glasses, smart headphones, and/or any suitable type of personal computing device. The customer application IES 110 may be an application service integrated into the normal operation of the device. The customer application IES 11o may alternatively be an optional application installed by a customer. The customer application IES 11o may be explicitly activated and executed during the shopping experience. The customer application IES 11o may alternatively automatically activate and execute.

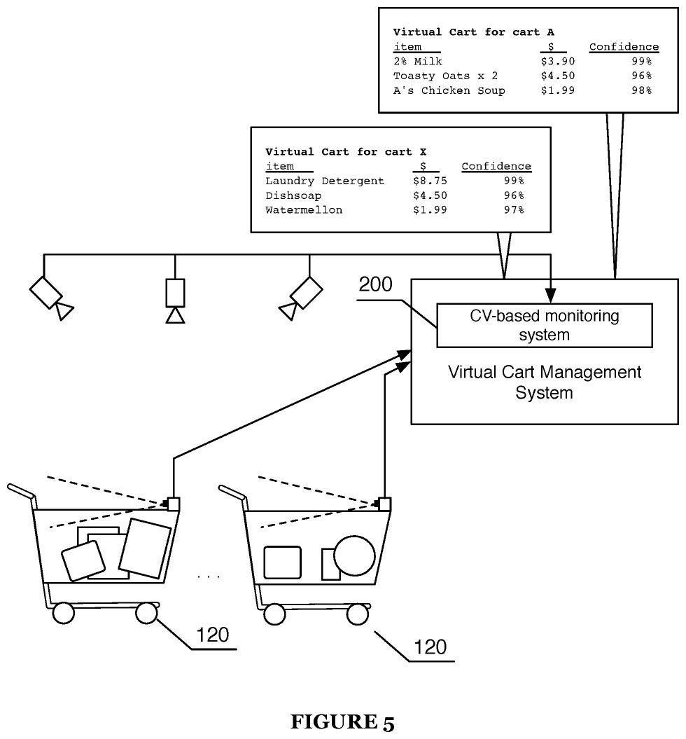

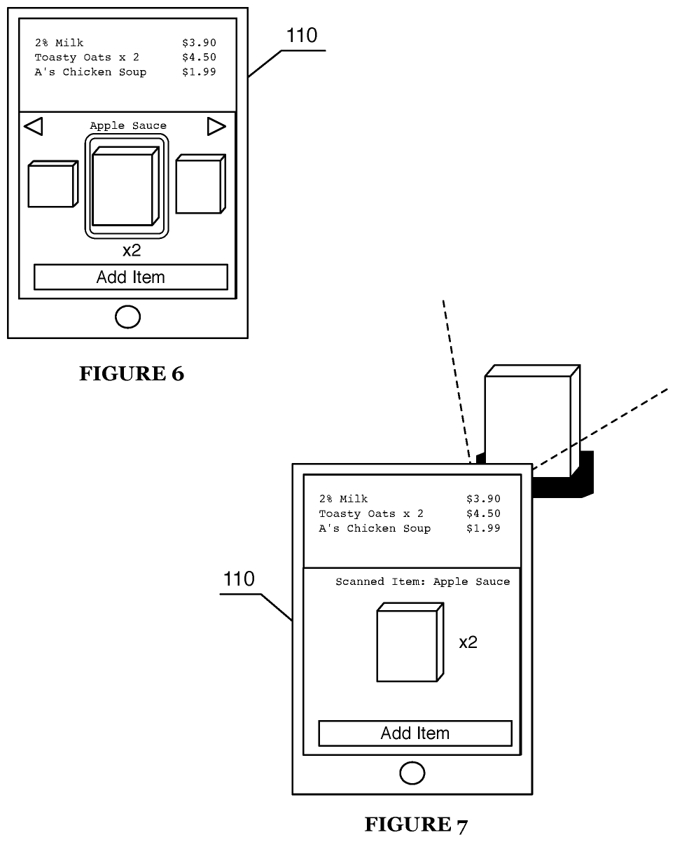

In one variation, the customer application IES 11o includes a manual item entry mechanism as shown in FIG. 6. In one implementation, the manual item entry mechanism is a user interface for a user to specify the items selected for purchase. Manual entry can include a graphical user interface where a customer selects products from a graphical user interface to add them to a checkout list. Manual entry could additionally use a camera of the computing device or other sensors to detect the item as shown in FIG. 7. For example, a customer could enter an item by pointing the camera of the computing device at the item and selecting an option to add it to the checkout list.

In one variation, location tracking and/or other contextual data of the environmental sensing system 200 may be used to augment the use or execution of the manual item entry mechanism. For example, a graphical user interface may present product options prioritized by the customer's location within the store as sensed or detected by the environmental sensing system 200. Location sensing by the customer application IES 11o could additionally or alternatively be used.

Items may be entered at approximately the time and location where they were selected or entered at later time in the shopping experience. In one variation, the system may be configured to enforce entry of items as they are selected. For example, the environmental sensing system 200 may detect an item was selected, and system may be configured to generate an alert if the item is not entered in a specified time and/or proximity to the location of item selection. This can function to avoid situations where a customer may forget to enter an item later on.

The customer application IES 11o can additionally be used for removing items if they are no longer desired, indicating the quantity of an item (e.g., number of items, item weight, etc.).

In one variation the customer application IES 110 is operable on a smart headphones or an alternative audio-interface based computing device. Such a device may include an audio-based user interface where speech commands are used to perform different actions. Such an audio-based device may or may not have a camera or other types of user input. In one variation, the system may still enable execution of an application by using the contextual sensing system 110 to substantially provide product identification data while user commands issued to the customer application IES 11o can be used for customer management of the virtual cart. For example, a customer may pick up an item and say “add item” or an alternative audio command, and then the currently held item as detected by an environmental sensing system 200 is added to a virtual cart of the customer. An exemplary set of audio commands may include “add item”, “remove item”, “price check item”, “add x items” (where x could be the number of items), and/or other types of audio commands.

In one variation, the customer application IES 11o is operable on smart glasses with a camera as shown in FIG. 3. Alternative types of computing devices with a wearable camera could similarly be used. In this variation, the smart glasses are configured to automatically detect item selection events from image data collected from the camera of the smart glasses. The image data can be used to automatically detect selection of an item and/or identify selected items. The camera on the person is preferably used to provide consistent high quality image data that can be analyzed through computer vision processes to detect item selection (e.g., adding an item to the virtual cart), item returns (.g., removing an item from the virtual cart), item identity detection, and/or other tasks used in managing a virtual cart. Selection of an item may be based on picking up of an item and/or detecting adding the item to a physical cart or bag. Alternatively, a user gesture performed in the view of the camera may be used as mechanism for signaling manual entry of an item with the image data. The smart glasses may continuously collect image data and dynamically detect item interactions. Alternatively, the environmental sensing system 200 may facilitate detecting when potential item interactions have or will occur such that the contextual data may be used to manage the operation of the smart glasses when used for autonomous shopping.

A smart cart IES 120 of a preferred embodiment, herein referred more concisely as a smart cart 120, functions to integrate item detection capabilities into a physical device used by customers to hold items. The smart cart 120 is preferably configured to generate a virtual cart during the shopping experience as items are selected for purchase. A smart cart 120 preferably generates the virtual cart proactively during the shopping experience such that a customer can have an expedited checkout process when the customer is ready to checkout since the items selected for purchase have been added to a virtual cart in substantially real-time. From the user experience of the customer, the virtual cart is automatically generated by simply collecting the items and adding the items to the smart cart 120. In some variations, the smart cart 120 may additionally detect and track item selection even when not stored in the smart cart 120.

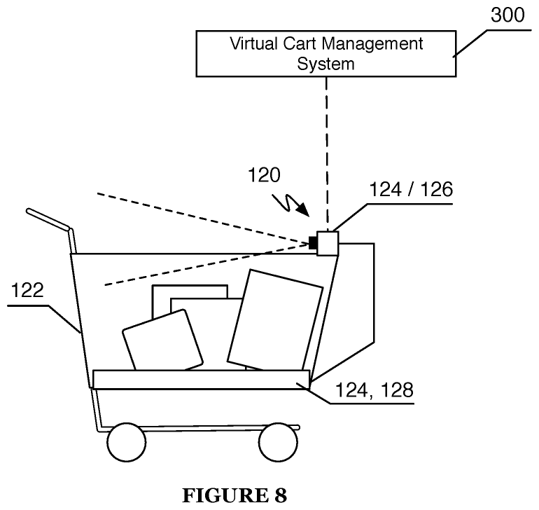

A smart cart 120 preferably includes a defined item receptacle 122 and at least one item detection sensor 124. In a preferred variation, the smart cart 120 includes a computer vision inspection system 126 and optionally a set of other supplemental sensing elements and a cart user interface like a digital scale 128 as shown in FIG. 8. The smart cart 120 can additionally include commonly available computing device components for facilitating functionality such as providing power, computing, communicating, storing data, and/or serving other computer device operations.

A shopping environment will generally offer a number of compatible smart carts 120 for use by customers. As with traditional shopping carts, the smart carts 120 are preferably reused by different customers. A shopping environment may additionally offer multiple versions of smart carts 120 such as a smart push cart, a smart hand-held basket, and/or other form factors.

The smart cart 120 preferably operates by communicating with a remote virtual cart management system 300 that is hosted within a local network, over the internet, or in another remote location. However, one implementation of the smart cart 120 may be a standalone version that includes an internal virtual cart management system such that the system can operate without sending outbound data communications for processing.

The item receptacle 122 functions as a physical structure used in carrying items. The smart cart 120 could be integrated with a shopping cart, a hand-held basket, a shopping bag, or any suitable element. The item receptacle 122 is preferably a defined cavity as in the case of a push cart or basket with a floor structure and a surrounding outer wall structure extending upwards from the floor structure. There may be multiple item receptacles 122 wherein each item receptacle 122 may be configured for monitoring by an item detection sensor 124. For example, a push cart may have a main item receptacle, an upper tray item receptacle, and a lower base tray, wherein each may have a dedicated or shared item detection sensor 124.

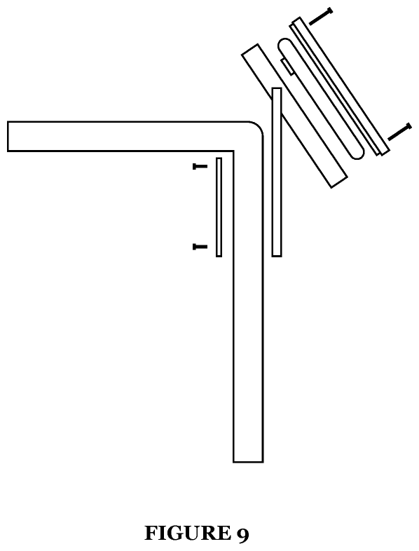

In one implementation, the system includes a cart attachment fixture such that a standard cart can be “upgraded” to a smart cart 120. The cart attachment fixture preferably enables an item detection sensor 124 and/or other computing elements to be securely attached to an existing cart. In one implementation, the cart attachment fixture is a multi-part rigid structure with a defined internal cavity to hold a mobile computing device (e.g., a smart phone) as shown in FIG. 9. In this variation, the computing elements of the system may be at least partially supplied by the computing device with the operational components directed by an application operating on the mobile computing device. For example, the camera of a smart phone may provide the visual data to the computer vision inspection 126 system running on the smart phone, and user interface components may be provided by a touch screen and speaker of the smart phone.

The item detection sensor 124 functions to detect item interaction events that can be used for generating a virtual cart. Preferably, a set of item detection sensors 124 can facilitate detecting when items should be considered selected and/or identify the items. The item detection sensors 124 may additionally measure other aspects such as weight or item measurements. An IES 100 may include one or more item detection sensor 124 in the set of item detection sensors 124. The item detection sensors 124 can also facilitate detecting when an item is removed or deselected in which cast the virtual cart may remove the appropriate item or adjust item count. In particular, the item detection sensor 124 is configured to detect adding an item to the item receptacle 122. The item detection sensor 124 can additionally be configured to detect removing an item from the item receptacle 122. This generally includes the collection of sensor data and processing of the sensor data.

An item detection sensor 124 is preferably a computer vision inspection system 126 but may additionally or alternatively be a scale, an RFID scanner, a barcode scanner, a volumetric scanner, and/or other suitable sensing element.

The computer vision inspection system 126 functions to make a visual inspection of items in proximity to the smart cart 120 and provide item identification when possible. The computer vision inspection system 126 preferably includes a camera system or access at data from a camera system. The camera system and/or computer vision inspection system 126 can be used to collect item selection input data where the item selection input is the type of item selection event (e.g., adding or removing) and item identification data from the computer vision processing of image data from the camera data. The camera system preferably utilizes video cameras but may additionally use still cameras. Depth cameras and/or other alternative imaging devices could additionally or alternatively be used. The camera system can collect any suitable combination of visual, infrared, depth-based, lidar, radar, sonar, and/or other types of image data.

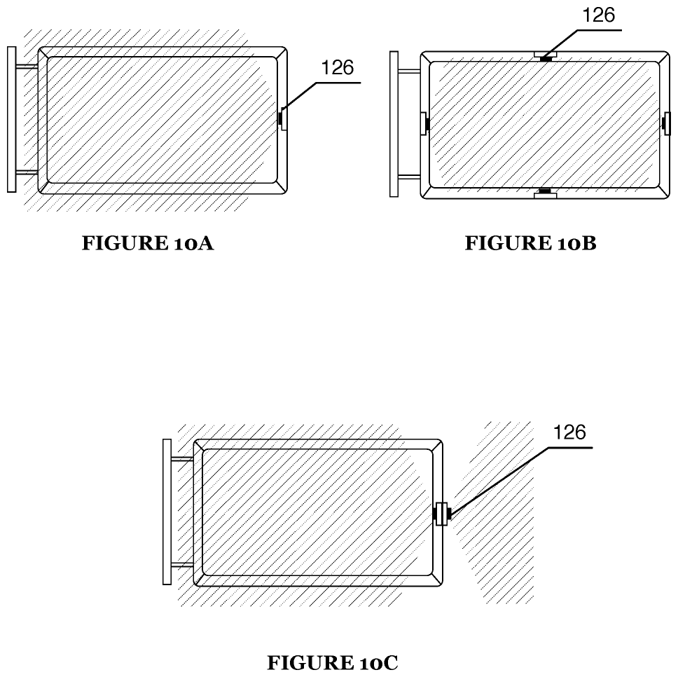

Preferably, the computer vision inspection system 126 includes an internal inspection system that functions to inspect items entering or previously entered in the item receptacle 122. The internal inspection system preferably includes at least one imaging device of the camera system that is directed inward at the item receptacle 122. The internal inspection system preferably collects image data with a field of view including the entire or a substantial view of a holding area of the item receptacle. One or more camera may be used as shown in FIGS. 10A and 1B. In one implementation, a front, back, left, and right cameras are positioned along the top edges of a cart and directed inward as shown in FIG. 10B. Clear visual images of a newly added item are preferably captured from one of the cameras as the item is added or after the item has settled in place in the item receptacle of the cart. Visual identification can further be enhanced by leveraging modeling from a supplemental detection system and/or other sensing inputs of the virtual cart.

The computer vision inspection system 126 may additionally or alternatively include an external inspection system that functions to inspect items and interactions outside of the item receptacle. The external inspection system preferably includes at least one imaging device of the camera system that is directed outward with a view outside or beyond the item receptacle. Preferably this is a view that does not include the item receptacle. The external inspection system may be used in place of an internal inspection system but is preferably a supplemental sensing input to the smart cart system. An external inspection system can collect visual data outside of the cart as shown in FIG. 10C.

As one element of functionality, the external inspection system may provide additional visual data on items selected by a customer. This may be used in modeling the items added to the smart cart 120. This may additionally be applied to building a deeper model of shopping behavior by identifying items selected but not ultimately added to a cart.

As another element of functionality, the external inspection system can collect local environmental visual data such as identifying products near the smart cart 120 at a given point in time. This may be used in biasing predictions of an item towards nearby items. For example, if a shopper is in a cereal aisle and an item is added, then the identification of that item may be weighted toward one of the nearby cereal options. This can alleviate dependence on a clear visual identification. As many stores use static and slowly changing item arrangement, such nearby item detection can be performed periodically to provide a form of location tracking within the shopping environment. Images of items captured by an external inspection system can be queried in an environment map. The environment map can associate items to locations wherein items in the image are used to predict an approximate location. Similarly, the environment map may associate visual representations of the environment with location data such that matching an image of a nearby shelf can be used to determine location. Here location may be mapped to a physical location but may alternatively be based on relative shelving displacement in the shopping environment.

The item detection system may additionally or alternatively include other sensing elements, which may include a digital scale, an RFID scanner, a barcode scanner, a volumetric scanner, and/or other suitable sensing elements. A digital scale can be integrated into the smart cart 120 so as to detect the weight of contents held in the item receptacle. The total weight and/or the changes in weight when adding or removing an item or items may be used in confirming or predicting selected items. In some cases, the weight can be used in calculating a total for items priced by weight. For example, the type of produce may be identified through the computer vision inspection system 126 but the total cost may be determined by the measured weight of the items. An RFID scanner and/or barcode scanner may be used to remotely scan items that are enabled with RFID tags and/or barcodes. A volumetric scanner may act similarly to the computer vision inspection system 126 but can use volumetric or depth sensing to obtain a three-dimensional map of contents in the item receptacle, items selected by a customer, and/or items in the vicinity of the smart cart 120.

The smart cart 120 can include a cart user interface, which functions to provide a mechanism for user interaction with the smart cart 120. The cart user interface preferably at least provides information to the user. The cart user interface can be part of a computing device integrated with the smart cart 120. The cart user interface may use any suitable type of user interface medium such as a display, audio signals or dialogue, indicator lights, and the like. The cart user interface can facilitate user feedback when an item is successfully detected, when an unknown item is detected, or when other events relating to the virtual cart occur. The cart user interface can additionally be used by a customer for checking-in and/or paying. For example, a customer could synchronize the smart cart 120 with an account and/or otherwise login to an account. The cart user interface may include a NFC, RFID, or QR code scanner used in temporarily associating a customer account with a particular smart cart 120. The cart user interface could additionally or alternatively include a card payment reader used to read credit cards, debit cards, gift certificates, and the like. In one variation, a user application operable on a mobile device of the customer can function as the cart user interface. A user application instance may be able to synchronize with a particular smart cart 120 in various ways. In one variation, an identifier of the smart cart (e.g., an ID number or a QR code) can be entered into the user application instance to associate the user application and paired customer account with a particular smart cart 120.

The smart cart 120 may additionally include a cart identifier, which functions to promote unique identification of the smart cart 120 by a supplemental detection system such as a remote computer vision monitoring system 210. The cart identifier can be an active identifier such as a blinking LED light or a unique signal transmitted by a short range RF transmitter. The cart identifier could alternatively be a passive identifier such as a machine-readable identifier graphic (e.g., QR code) or a human readable ID. In alternative implementations, the contents of a cart can be used as an at least partially identifying marker. A synchronization engine may alternatively identify and track the identity of the smart cart 120 in other suitable approaches as described herein.

The system can additionally include a cart docking system that can facilitate physical storage, electrical charging, and/or device synchronizing of multiple smart carts 120. The physical design of the smart carts 120 preferably enables vertical or horizontal stacking as is common in traditional carts. The stacking arrangement can additionally promote conductive coupling between multiple smarts carts, which can be used for charging and/or communicating with the smart carts 120. Alternative approaches for conductive coupling may be used such as wireless charging and/or communication. When docked in the cart docking system, the system may collect data from the smart carts 120, perform system updates, reset the operating modes, or perform any suitable task.

### Environmental Sensing System

The environmental sensing system 200 of a preferred embodiment functions to provide redundancy, validation, and/or improved management of a virtual cart generated and tracked by the system.

The environmental sensing system 200 serves as a supplemental monitoring system that is distributed through the shopping environment and configured to collect contextual data of customer activity in the environment. The environmental sensing system 200 is preferably substantially permanently integrated into the environment. While the IES 100 will generally accompany a customer during a shopping experience, the environmental sensing system 200 preferably includes a set of sensors installed in the store. Preferably, the environmental sensing system 200 comprising at least a computer vision monitoring system 210. The environmental sensing system 200 may additionally or alternatively include a wireless tagging system, a smart infrastructure/shelving system, or other suitable sensing or detection systems.

The environmental sensing system 200 preferably provides at least one vector of contextual state data to the virtual cart management system. The contextual data may be used to augment detection of an item selection event (e.g., when was an item selected or deselected), identification of an item, and/or validate or assess the state of the virtual cart (e.g., is there a potential error or issue with the virtual cart).

The environmental sensing system 200 may generate customer location information, item identity information, secondary virtual cart predictions, customer behavior information, and/or other suitable types of information.

In one variation, the environmental sensing system 200 provides location contextual state information. The location of a customer and/or the IES 100 may be detected and tracked through the environmental sensing system 200. The location contextual state information can relate to the absolute or relative position of a smart cart within a shopping environment. By understanding the location of an IES 100 the probability of items selected and added while at that location can be used to alter the item identification process of the IES 100. In one variation, relative location can be based on proximity to items within the shopping environment. Item proximity may be based on item location maps configured for a shopping environment. Item proximity may additionally or alternatively be modeled and learned as items are identified through the system.

In another variation, the environmental sensing system 200 provides item identification contextual information. The item identification contextual information may facilitate identifying an item when the IES 100 is unable to accurately identify an item. The item identification contextual information may alternatively be used in combination with data collected from an IES 100 to predict an item identity.

In another variation, the environmental sensing system 200 provides virtual cart predictions as contextual information. Virtual cart predictions may be an independently generated virtual cart, wherein the IES 100 may generate a first virtual cart, and the environmental sensing system 200 may generate a second virtual cart. These may be compared to assess accuracy. These may alternatively be combined to form a resulting virtual cart that is preferably more accurate and/or comprehensive.

In another variation, the environmental sensing system 200 provides customer behavior as contextual information. The customer behavior data may be used to alter predictions or augment assessment of the virtual cart.

The contextual data may alternatively be applied in any suitable way. Different types of environmental sensing systems 200 may contribute to different types of contextual data that can be used in different ways. Preferably, the environmental sensing system 200 includes a computer vision system 210. The environmental sensing system 200 may additionally or alternatively include a wireless tagging system, a smart infrastructure system, and/or other types of sensing systems.

The computer vision monitoring system 210 functions to collect image data and apply computer vision processing to extract contextual data from across the environment. Preferably, the computer vision monitoring system 210 can detect and track contextual data specifically associated with a customer. The CV monitoring system 210 can additionally track customer activity for multiple customers simultaneously, such that the system may support management of multiple virtual carts simultaneously.

The CV monitoring system 210 can be applied for collecting a variety of types of contextual data. The CV monitoring system 210 could track location of a customer, detect and identify items near a customer, detect item selection events, identify items that were selected, identify a customer to access customer profile data, classify behavior of the customer, and/or perform other tasks. In one variation, the CV monitoring system 210 may be used to generate a second virtual cart, which may be performed in a manner substantially similar to the system and method described in US Patent Application publication No. 2017/0323376, filed 9 May 2017, which is hereby incorporated in its entirety by this reference. In this variation, the computer vision monitoring system is configured to generate an at least partial prediction of item selection by the customer. The at least partial prediction of a virtual cart can process by the virtual cart management module to assess confidence in the virtual cart.

An IES 100 (e.g., a smart cart or application operable on smart glasses) and an environmental computer vision monitoring system 210 in one variation can be used in combination to collect a greater variety of visual data on the items selected for purchase. The IES 100 and computer vision monitoring system 210 could alternatively be used in combination to coordinate what data to be analyzed and when. For example, the adding of an item to a cart may be detected through a smart cart 120, which can trigger the visual processing of images at and leading up to the time when the item was added. In another example, the CV monitoring system 210 can be used to detect selection of an item by a customer, and the system could provide feedback to a user in a user application prompting them to self identify the recently selected product.

The CV monitoring system 210 will preferably include various computing elements used in processing image data collected by an imaging system. In particular, the CV-driven imaging system will preferably include an imaging system and a CV-based processing engine and data management infrastructure.

The imaging system functions to collect image data within the environment. The imaging system preferably includes a set of image capture devices. The imaging system might collect some combination of visual, infrared, depth-based, lidar, radar, sonar, and/or other types of image data. The imaging system is preferably a distributed camera system with imaging devices positioned at a range of distinct vantage points. However, in one variation, the imaging system may include only a single image capture device. The image data is preferably video but can alternatively be a set of periodic static images. In one variation, the imaging system may collect image data from existing surveillance or video systems. In this variation, the system includes an image data interface to collect and/or receive image data from live imaging devices or from a data record. The image capture devices may be permanently situated in fixed locations. Alternatively, some or all may be moved, panned, zoomed, or carried throughout the facility in order to acquire more varied perspective views. In one variation, a subset of imaging devices can be mobile cameras (e.g., wearable cameras or cameras of personal computing devices). For example, in one implementation, the system could operate partially or entirely using personal imaging devices worn by humans in the environment. The image data collected by the human and potentially other imaging devices in the environment can be used for collecting various interaction data.

In a shopping environment, the imaging system preferably includes a set of statically positioned image devices mounted with an aerial view from the ceiling. The aerial view imaging devices preferably provide image data across stored products monitored for virtual cart functionality. The image system is preferably installed such that the image data covers the area of interest within the environment (e.g., product shelves). In one variation, imaging devices may be specifically setup for monitoring particular items or item display areas from a particular perspective. Since the CV monitoring system 210 may act as a supplemental detection system, the imaging system may not fully cover an environment, and may collect image data from a subset of regions.

A CV-based processing engine and data management infrastructure preferably manages the collected image data and facilitates processing of the image data to establish various modeling and conclusions relating to interactions of interest. For example, the selection of an item and the returning of an item are or particular interest. The data processing engine preferably includes a number of general processor units (CPUs), graphical processing units (GPUs), microprocessors, custom processors, and/or other computing components. The computing components of the processing engine can reside local to the imaging system and the environment. The computing resources of the data processing engine may alternatively operate remotely in part or whole.

The CV monitoring system may additionally or alternatively include human-in-the-loop (HL) monitoring which functions to use human interpretation and processing of at least a portion of collected sensor data. Preferably, HL monitoring uses one or more workers to facilitate review and processing of collected image data. The image data could be partially processed and selectively presented to human processors for efficient processing and tracking/generation of a virtual cart for customers in the environment.

The system may additionally include additional sensing systems such as a customer location tracking system. Location tracking can use Bluetooth beaconing, acoustic positioning, RF or ultrasound based positioning, GPS, and/or other suitable techniques for determining location within an environment. Location can additionally or alternatively be sensed or tracked through the CV monitoring system 120. The CV monitoring system 120 can include a customer tracking engine that is configured to track customer location. Preferably, the customer location can be used to generate contextual data of customer location relative to the environment. This may be used to detect items in proximity to a customer. Nearby items can be set as a set of candidate items, which may be used to bias or prioritize identification of an item during management of the virtual cart.

A wireless item tagging system functions to use identifiable tags attached to items and a wireless mechanism to inspect the tags to detect the removal of an item from storage and/or the adding of an item to a physical cart, basket, or bag. RFID, NFC, and/or other suitable forms of wireless item tagging may be employed. Tag identification may be used to detect the selection of items, identify items, and/or to generate an at least partial virtual cart for comparison to a virtual cart of an IES 100 or verify virtual cart accuracy.

In one implementation, a wireless item tagging system is used in selective monitoring of a subset of the inventory items. For example, a sampling of different inventory items may be tracked through attaching RFID tags to a subset of items. The items that are tracked may provide a sanity check to the virtual cart generated through the IES 100.

A smart infrastructure monitoring system functions to perform other forms of product, equipment, or people tracking. Smart infrastructure monitoring system may include or be used alongside a CV monitoring system and/or an RFID-based monitoring system. A smart infrastructure monitoring system can include digital scales, proximity sensors, mechanical sensors, wireless tagging systems, and/or other suitable forms of sensing. Preferably, the smart infrastructure includes smart shelving that includes one or more sensors as described herein. In one particular variation, digital scales and/or item tracking sensors can be integrated with shelving units to monitor individual items during storage. The smart infrastructure monitoring system can track item removal from a shelving unit and preferably track that as an item is removed by an individual person or by a possible set of people. In some implementations, the smart infrastructure monitoring system can be used in combination with the RFID-based monitoring system in providing selective monitoring of a subset of items in an environment. The scales and sensor fusion approaches to monitoring may be used in select areas or for select products such as products commonly purchased, with a high value, or selected for any suitable reason.

In some implementations, the system may more generally include other forms of supplemental detection systems, which can more generally include any suitable system that collects and provides additional contextual data that is used to augment the virtual cart management system 300. A supplemental detection system may include one or more types of environmental sensing systems 200 described herein, but may additionally or alternatively include an IES positioning system, a customer profile system, or other systems that can supply alternative forms of contextual data.

An IES positioning system functions to detect location information of the IES 100. GPS, local positioning systems, RF triangulation, image mapping (e.g., mapping images to environment locations), and/or other positioning systems may be used so that each IES can detect an absolute or relative position within the shopping environment. For example, each smart cart may include a cart-based positioning system so that the location of each smart cart can be detected. The IES positioning system may be used to limit, prioritize, or otherwise gate, the item identification process. For example, a computer vision product identification process may be a machine learning model trained to detect a large number of items. However, the IES positioning system may be applied so that the product identification process prioritizes or even initially only considers a subset of items in near proximity to the IES and customer.

A customer profile system functions to access customer related data that can be used in enhancing the identification process of the smart cart. A customer profile system can include customer history, preferences, and/or other information. The customer profile can include data for a specific customer but additionally or alternatively include data for one or more segments of multiple customers (e.g., classifications of customers and/or all customers). A profile prediction system can use data of a particular person, class of person, the store, or other data scopes to generate predictions and/or assess likelihood of predictions from another monitoring system. In particular, the profile prediction system can use shopping history to determine likelihood of accuracy of a checkout process as detected by a primary system. For example, customers that historically attempt to mislead the system may be more likely to do so again. In another example, customers that historically confuse the system due to legitimate shopping habits may also be more likely to do so again. In another example, a shopper selecting items that are predictively aligned with past behavior is probably being monitored accurately, and a shopper modeled as having selected items by a primary system may be determined as likely not modeled accurately if those items are not aligned with expected purchase patterns.

A profile can additionally be updated for different visits/shopping experiences. In some cases, the profile prediction system may even be used in combination with another supplementary system.

The profile prediction system may use a variety of types of data such as purchase history, completeness of a profile (e.g., address, name, email, phone number, etc.), age verification, premium membership, social media account connection, biometric profile, payment information, and/or other details. In some implementations, users with more complete and verified information will be more accountable and therefore may be less likely to deliberately mislead the system.

These various monitoring systems may be used in any suitable combination.

The system may include synchronization engine functions to establish an association of the IES 100 in the environment with the corresponding model representation from the environmental sensing system 200. In the case where the environmental sensing system 200 is a CV monitoring system 210, the corresponding model can be the CV-agent detected and tracked in the environment. The CV-agent may be a CV-person or CV-IES. A CV-person is preferably a detected person that may be associated with the customer using the IES 100. A CV-IES is preferably a detected IES device in the image data that may be identified through an IES identifier. The synchronization preferably maps the appropriate CV-agent with an identified IES 100 The virtual cart management system 300 can then match the appropriate contextual information with the input from the IES 100.

The system can additionally include a virtual cart management system 300 that functions to maintain state of a virtual cart of an IES 100. The virtual cart management system 300 can be configured to detect an item selection event, identify a selected item, and update the state of the virtual cart with the item of the selection event. More specifically, the virtual cart management system 300 can facilitate adding items and removing items from the virtual cart as items are selected or deselected for purchase by a customer.

### Virtual Cart Management System

The virtual cart management system 300 preferably includes a database of candidate items and their associated properties. Item properties may include visual training data, weight, dimensions, store locations, popularity, related objects (e.g., similar items, items commonly purchased along with it), purchase history, price, and/or other suitable information. In some cases, the virtual cart management system 300 can manage processing multiple vectors of item identification such as a first set of item identification information from the IES 100 and a second set of contextual state information from an environmental sensing system 200. Alternatively, the item identification process of the IES 100 and environmental sensing system 200 may have been processed prior to updating the virtual cart management system 300. The virtual cart management system 300 can additionally be used in completing a transaction with the virtual cart such as purchasing the items, renting the items, and/or performing any suitable action.

The virtual cart management system 300 can additionally manage assessing the virtual cart. Assessing the virtual cart can include measuring or classifying some confidence or accuracy related metric. Preferably, the virtual cart can have a confidence metric that is a measure of confidence in the validity of the virtual cart. For example, a confidence metric can indicate a measure of confidence in the accuracy of the virtual cart. The assessment may additionally be confidence metrics per item. For example, a confidence metric could be a measure of expected accuracy of a particular item belonging in the virtual cart.

The virtual cart management system 300 is preferably at least partially augmented by the contextual data. Detection of an item selection event, identification of a selected item, and/or assessment of a virtual cart are possible processes of the virtual cart management that can be augmented by the contextual data.

Augmentation of the virtual cart management system 300 can improved detecting when an item is added or removed for purchase, improve recognizing items, and/or detecting scenarios where the virtual cart may be inaccurate (e.g., due to errors in sensing, improper use of the system, attempts of theft, or other issues).

### 3. Method

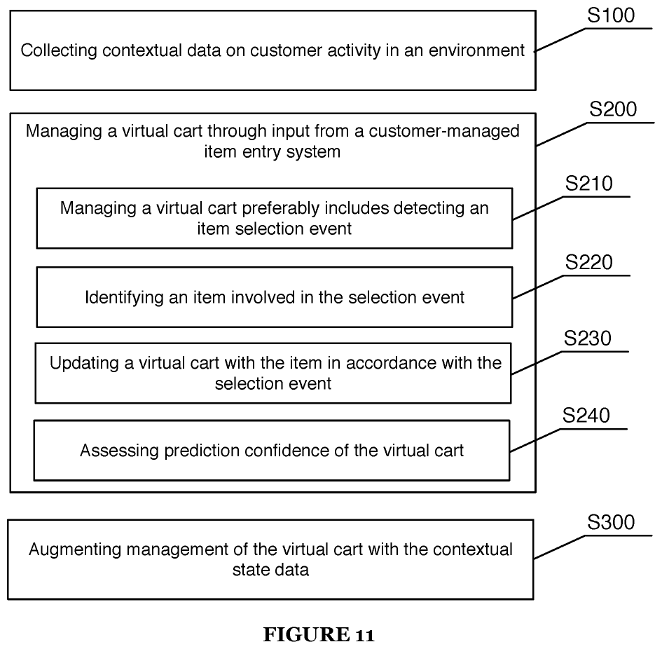

As shown in FIG. 11, a method for a contextually aware customer item entry for autonomous shopping applications of a preferred embodiment can include collecting contextual data on customer activity in an environment S100; managing a virtual cart through input from a customer-managed item entry system S200; and augmenting management of the virtual cart with the contextual state data S300. Managing a virtual cart preferably includes detecting an item selection event S210; identifying an item involved in the selection event S220; and updating a virtual cart with the item in accordance with the selection event S230. Augmentation of the virtual cart management can be applied to any suitable part of virtual cart management.

The method functions to utilize at least one secondary system to augment tracking of an IES as discussed above and tracking of its associated virtual cart. The detection process and capabilities of an IES may be enhanced by leveraging additional context information to improve the item identification and/or to verify the level of trust for item accounting of a customer using an IES. The method preferably utilizes a system such as the one described above, but may alternatively be implemented by any suitable system.

In one embodiment, location-based contextual state information is employed where the location of a smart cart is detected and a set of candidate items is prioritized for identification based on proximity to the location of the smart. Location contextual state can be used to improve the accuracy of a CV-based smart cart.

In another embodiment, a CV monitoring system is used to remotely track items added to the smart cart, and the data from an environmental CV monitoring system and the IES is used in combination to identify items added to a smart cart. The method may be used in combination with an IES that is a smart cart, a customer application, smart glasses, or other suitable devices. Cart-specific sensing in combination with remote sensing of the environmental CV-based monitoring system may provide comprehensive detection and redundancy that can enhance accuracy and validation of tracked items in a smart cart. In one implementation, the environmental CV-based monitoring system can be a redundant check of the smart cart, and can be used to detect scenarios when a generated virtual cart may not accurately reflect the actual contents of the smart cart.

Block S100, which includes collecting contextual data on customer activity in an environment, functions to supply at least one additional source of information that can be used in combination with customer-managed IES.

The contextual data is preferably collected from at least one environmental sensing system such as the variations described herein. The contextual data may additionally be collected from multiple types of environmental sensing systems.

In a first variation, the contextual state information is information related to the location of the IES. In a second variation, the contextual state information can be remotely detected data or item selection predictions for an IES. In a third variation, the contextual state information can be customer profile information. In one preferred variation, the environmental sensing system is a computer monitoring system which may facilitate tracking customers, tracking IESs, detecting item selection events, identifying items that were involved in a selection event, generating a secondary/redundant virtual cart, and/or performing other tasks.

In the variation using location information, detecting contextual state of the IES can include detecting location of the IES and/or customer. The location is preferably within the context of the shopping environment. For example, the location could be a local description such as “aisle 6, section 4”, “cereal section”, or “x:120 ft, y:308 ft”. Location can be used to determine proximity to stored items in the shopping environment, which can be used to augment the identification of items added to a smart cart. In one implementation, an environmental positioning system can perform RF triangulation, querying Bluetooth beacons, or using other suitable techniques to determine location. In another implementation, remote visual tracking of the IES can be used to detect the location. An IES may be tracked through the shopping environment using remote cameras distributed in the shopping environment as part of the CV monitoring system. CV-based processing can track the cart, IES, and/or the customer. In one variation, a unique identifier on a smart cart or other physical type of IES can be tracked. The IES can transit an identifying signal (e.g., an optical signal, audio signal, electromagnetic signal, etc.) or be marked by a detectable tag. The environmental sensing system could detect the identifier and associate that detected object with the appropriate IES. Accordingly, collecting contextual data can include detecting location of a unique identifier associated with the IES. In another CV-based approach, background imagery captured by one or more cameras of the IES can be used in determining a location within the shopping environment. In a related alternative variation, location may not be detected directly, and instead proximity to items can be detected.

In the variation using remote item detection, detecting contextual state of the IES can include at least partially detecting an item selection event and/or identifying items through an environmental sensing system. In the computer vision monitoring variation, image data from one or more cameras positioned in the shopping environment can be processed to detect item selection for an IES. The image data is preferably distinct from item related data collected by an IES. In some cases, the IES may also use computer vision analysis from included cameras. The cameras of environmental sensing system could supplement this image data and computer vision analysis.

Image data from a remote imaging device may be used to detect item-customer and/or item-IES interactions which may include detecting customer grabbing an item, customer placing an item in a cart, customer returning an item to a shelf, an item entering a cart or bag, an item leaving a cart or bag, and the like. Detection of such events may augment detection of an item selection event, but could alternatively be solely responsible for determining selection events.

Image data from a remote imaging device may be used to identify an item during item selection but could alternatively be used to identify an item at a different location or point in time. For example, an item may be more confidently identified when a remote imaging device obtains image data when a more clear view of the item is available. In some variations, the environmental CV monitoring system can additionally or alternatively be used in other CV-based tasks used to identify selected items.

Additional or alternative tasks of the CV monitoring system can include classifying an item (e.g., narrowing the candidate items), detecting events related to customer selection of an item, matching a customer to a smart cart, and/or other tasks. For example, the CV monitoring system may be able to generate an output that corresponds to the probability of a customer selecting items—this can then be used in changing the operating mode of the smart cart to prepare for identifying new items.

As another variation of using remote item detection, detecting contextual state of the smart cart can include detecting an item tag, which can function to use a non CV-based approach to detecting and identifying an item. An item tag could be an RFID tag. A wireless tagging system could detect removal of an item from a shelf, movement of an item, and/or position of an item, adding of an item to a cart, and/or other events using an item tag.

In the variation using customer profile information, detecting contextual state of the smart cart can include associating a customer profile temporarily to the IES. A customer profile can provide information on purchase history, purchase patterns, shopping lists, and/or other properties. A customer profile may be associated with an IES by identifying a customer through biometric identification enabled by the computer vision monitoring system or by a camera system on the IES. A customer profile may alternatively be associated with an IES by receiving a customer identifier through the IES or other system devices. For example, a customer may scan a customer identifier (e.g., a QR code, or audio coded identifier) into an IES (e.g., a customer application and/or a smart cart).

Block S200, which includes managing a virtual cart through input from a customer-managed item entry system, functions to collect item information for a virtual cart and update a virtual cart accordingly. This generally includes determining what items to add or remove from the virtual cart. A virtual cart is preferably managed throughout a shopping experience such that new data on item selection related events may result in updates to the virtual cart. The item entry system, as described above, is preferably movable through the environment. A virtual cart can thus be updated at multiple locations through the environment. In one variation, the item entry system is a customer application instance operable on a customer computing device. The customer computing device could be a smart phone, a smart watch, a tablet, smart glasses, smart headphones, and/or any suitable type of personal computing device. In another variation, the item entry system is a smart cart comprising at least one item detection sensor. The smart cart could be substantially similar to one described herein. In some variations, the IES presents a user interface wherein a customer manually enters at least partial item information that is used to update the virtual cart. In other variations of the IES, the IES includes at least one sensor to collect data that is then processed to facilitate management of the virtual cart.

Blocks S210 and S220, which include detecting an item selection event and identifying an item involved in the selection event, function to determine the items to be added or removed from a virtual cart. Additionally, the quantity of an item or other attributes of an item that may contribute to how its represented in a virtual cart may additionally be detected such as the weight of a produce item.

In one variation, detecting an item selection event and identifying an item involved in the selection event includes receiving manual selection of an item through a user interface of the customer application instance. This is preferably used where a customer explicitly facilitates at least part of item entry such as when using an autonomous checkout application on a smart phone. This process may be fully manual where a user indicates if an item is being added or removed, the identity of the item, and optionally any other needed information such as weight. Alternatively, a portion of this can be manual. For example, the IES or the environmental sensing system can detect when an item is added or removed and prompt the user to identify the involved product.

In another variation, detecting an item selection event and identifying an item involved in the selection event includes collecting image data from a camera of the item entry system and automatically detecting an item selection event and identifying the item from computer vision processing of the image data. The image data may come from the IES and/or the environmental sensing system. This approach is preferably applied for smart cart implementations and smart glasses implementations. CV-based processing can apply any suitable object classification, image segmentation, event or gesture detection, or other suitable processes.

Detecting an item selection event in particular functions to determine when an item is selected and should be counted as being added or removed from a virtual cart. An item selection event may be achieved in different ways depending on the type of IES. In a smart cart variation, detecting an item selection event may include detecting customer item interaction from a sensor of the IES. This may include detecting a customer interacting with items on the shelf. This more preferably includes detecting an item transitioning in and out of the opening of an item receptacle of the smart cart. In other words, the smart cart can detect when items cross a defined threshold in proximity to the item receptacle. Detection of an added item selection event preferably triggers identifying the added item. In a smart glasses variation, this will generally include automatically detecting customer-item interactions, which may include detecting grabbing of items, adding item to a cart or storage device (e.g., coat pockets), removing an item from a cart, placing an item on shelving (e.g., returning an item), and/or any other suitable interactions. In a customer application variation, an item selection event may be when a user manually selects to add or remove an item from within a user interface (e.g., graphical user interface or an audio user interface).

Identifying an item functions to match a product identifier to the object selected for purchase. Visual object recognition is preferably used, but other sensor inputs can additionally be used in identifying an item such as weight, volume, location, contextual data, and/or other inputs. A smart cart for example preferably uses visual identification, but can additionally use weight changes, item scanners (QR code scanners, barcode scanners, and/or RFID tag identifiers) in identifying an added object. Image data from one or more cameras may be processed for item identification.

Block S230, which includes updating a virtual cart with the item in accordance with the selection event functions to appropriately add or remove items from the virtual cart. When the selection event is an added item, updating the virtual cart includes adding the identified item. When the selection event is a removed item, updating the virtual cart can include removing the identified item.

Managing the virtual cart can additionally include assessing prediction confidence of the virtual cart S240, which functions to qualify the validity of a virtual cart. A prediction confidence may be generated for the overall virtual cart and/or for individual items. The confidence can be altered based on confidence levels of data analysis processes. For example, a CV-based process may classify an item with a particular confidence metric. The confidence may alternatively or additionally be based on scenario analysis from other data inputs. In one implementation, the virtual cart may be analyzed in connection to contextual information, and potential errors may be detected. For example, the virtual cart may indicate a set of items were added at a certain time, but the contextual information may indicate such items would be unlikely based on customer location at that time. In another example, the contextual information may indicate that a set number of item selection events were detected but not reflected in updates to the virtual cart. This may be indication that items were not properly added to the virtual cart. These examples could lead to low confidence scores.

Block S300, which includes augmenting management of the virtual cart with the contextual state data, functions to use the contextual data in some way to alter the management of the virtual cart.

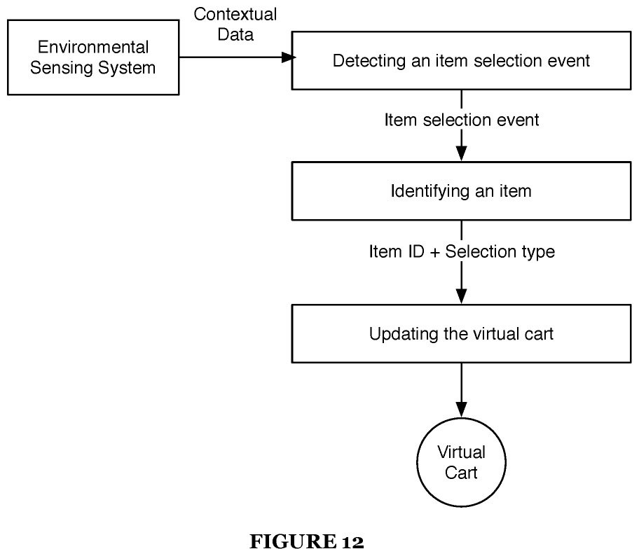

In one variation, augmenting management of the virtual cart includes augmenting the detection of an item selection event as shown in FIG. 12. Data collected from the environmental sensing system may be used to alter the detection of a selection event. In one variation, the environmental sensing system may be solely responsible for detecting item selection events. This may be used to determine if an item was added for each selection. In another variation, the environmental sensing system may provide supplemental data. Then detecting an item selection event can include detecting an item selection event from data collected from the IES and at least part of the contextual information.

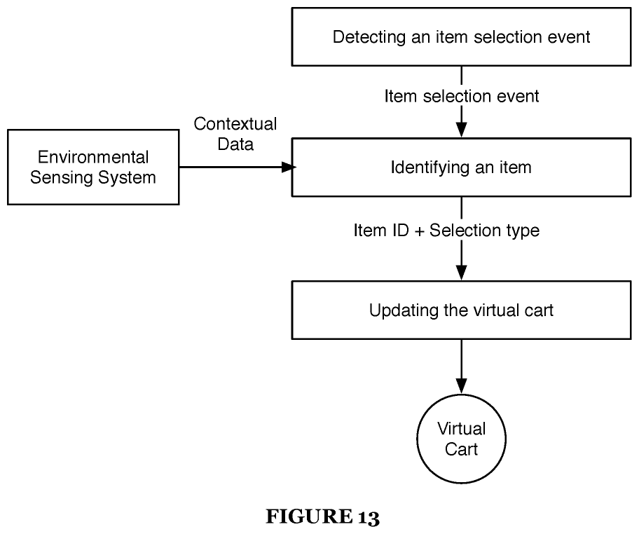

In another variation, augmenting management of the virtual cart can include augmenting the identification of the item as shown in FIG. 13. Augmenting the identification of the item functions to leverage data collected from the IES in combination with the contextual state information to enhance item identification.

In one variation, identifying the identification of the item can include prioritizing candidate items by item proximity based on the location contextual information. The location can be the location of the IES, the customer, and/or any suitable object accompanying the customer. In this variation, the contextual data can include a set of candidate items in proximity to the customer; and augmenting the identification of the item can include prioritizing the set of candidate items when identifying the item. For example, items that are detected or expected to be closer to a smart cart at the time an item is added may be weighted or otherwise indicated to be more likely for being the added item. Recent locations of the smart cart can additionally be used to account for situations such as a customer selecting an item from a shelf, walking down an aisle, and then adding to the smart cart.

In another variation, visual data from the IES and from an environmental computer vision monitoring system can be used in combination for CV processing. Processing results of the IES can be used to alter processing of image data from the remote imaging system. Similarly, processing results for image data from the remote imaging system can be used to alter the processing of image data from the smart cart. In one exemplary scenario, image data from a different point of view may be better suited for identifying an item.

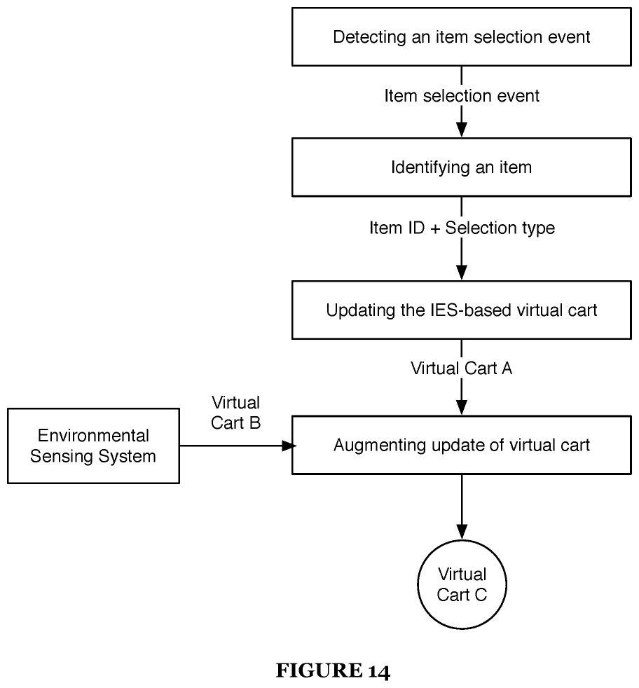

In another variation, the environmental sensing system may independently identify an item, and this could be compared to the item identification generated by the IES. A resulting virtual cart prediction may result where the two virtual carts are used to form a combined virtual cart as shown in FIG. 14.

In another variation, a customer profile can be used to alter the likelihood of items. For example, an item that was previously purchased by a customer may be prioritized as being likely for a subsequent purchase. In some cases, information from the customer profile can be used to alter the confidence level when item identification is less than satisfactory.

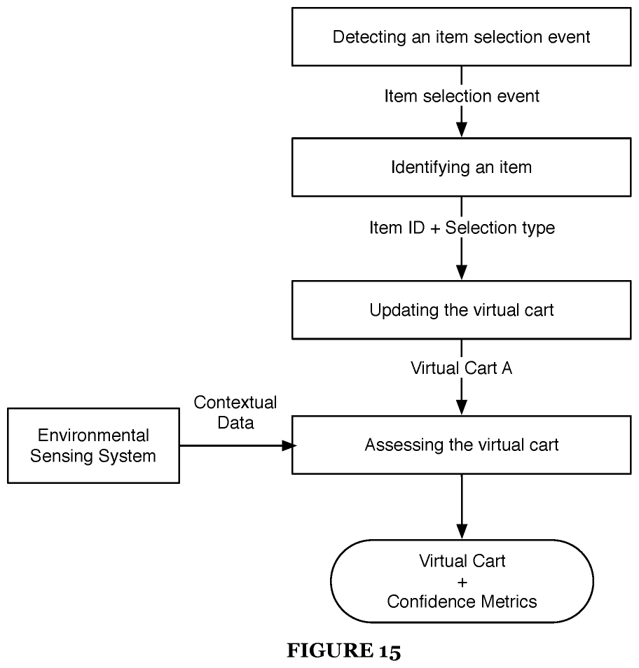

In another variation, the contextual data may be used with assessing a prediction confidence of the virtual cart. In this variation, augmenting management of the virtual cart can include augmenting assessment of the prediction confidence as shown in FIG. 15. The environmental sensing system may detect potential errors in the virtual cart, omitted items, or other predicted items contained in the cart.

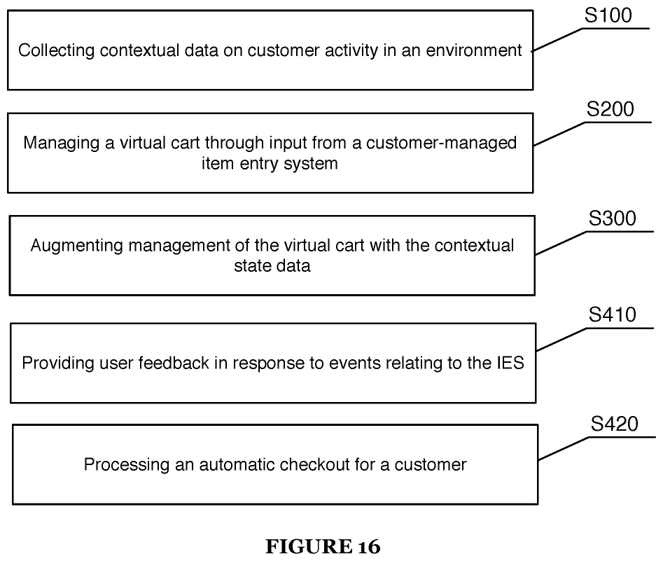

The method can additionally include providing user feedback in response to events relating to the IES S41o as shown in FIG. 16. In some instances, the user feedback may be triggered for an event detected by the IES. For example, if an item is not identified when entering a smart cart, the customer may be notified that the item was not identified. In other instances, the user feedback may be triggered for an event detected by a supplemental detection system. For example, a remote imaging system may detect that an item was added to the smart cart without detection by the smart cart, and the customer may be notified to facilitate proper identification.

User feedback can be in the form of an audio signal, synthesized or recorded voice messages, an indicator light, a displayed text alert, vibration or haptic feedback, and/or any suitable form of user feedback. User feedback can include affirmation of item identification. For example, a positive sounding tone may be played when an item is successfully added. User feedback can additionally be used to notify a customer to an issue. In some cases, the user feedback may prompt a customer to facilitate rescanning an item, confirming an item, confirming or entering the quantity of an item (e.g., entering the number or weight of an item), or notifying the customer of other issues or requests. The user feedback could also inform the customer to changes in an automatic checkout procedure. For example, if alcohol is added to a smart cart, the customer may be notified that they will need to see a worker station to show a form of ID before completing a purchase.

The method may additionally include processing an automatic checkout for a customer S420 as shown in FIG. 16, which functions to complete the transaction. The method is preferably used to facilitate the charging of a customer for goods. Here charging preferably includes charging a credit cart, debit card, deducting a virtual currency, or charging a suitable account. The method can include notifying a customer to a pending or executed transaction. The transaction may include a list of the total and the set of items included in the total. Adjustments or assumptions that were made based on cost-benefit analysis may be indicated in a summary. In one variation, the checkout summary may be sent to a customer when or after a customer exits a checkout region (e.g., near an exit or near a checkout station). Adjustments or issues may be resolved in the summary within a wait period defined by some time period and/or within a geo-fenced region. The actual financial charge may be initiated after the wait period. The method may similarly be applied for managing or crediting an account for non-financial transactions. For example, a library, warehouse, an equipment facility, or any suitable storage facility may use the system for accounting for the removal (and addition) of items. In some variations, an account check-in event is reserved for completion during checkout. Accordingly, the method can support directing customers to complete an automatic checkout process by checking-in to associate the virtual cart and the automatic checkout process with a user-account. In one implementation, automatic checkout station (which may also operate as assisted checkout station), where a user may check-in (using NFC, RFID tagging, entering account information, biometric recognition, and the like) and/or simply pay for the total of the virtual cart. Support for simple payment without setup of an account may be attractive to particular users. Worker-based stations could similarly facilitate such payment and automatic checkout. In one implementation, a virtual cart may be transmitted automatically to an identified checkout station upon the customer approaching the checkout station. Alternatively, the virtual cart may be transmitted to the checkout station upon the customer checking-in at that checkout station (e.g., scanning a customer identifying identifier that has been associated with the virtual cart). The items from the virtual cart can be automatically entered into the checkout station for quicker processing.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

We claim:

1. A system for autonomous checkout comprising:
an environmental sensing system distributed through a shopping environment that is configured to collect contextual data of customer activity in the environment;
the environmental sensing system comprising at least a computer vision monitoring system, the computer vision monitoring system comprising a set of imaging devices distributed through the environment;
a customer-managed item entry system that is movable through the environment by the customer and that is configured to collect item selection input;
a virtual cart management module configured to manage a virtual cart with the item selection input and augmented at least in part by the contextual data, wherein the virtual cart is used in execution of an autonomous checkout process.

2. The system of claim 1, wherein the computer vision monitoring system is configured to generate an at least partial prediction of item selection by the customer and wherein the at least partial prediction of a virtual cart is processed by the virtual cart management module to assess confidence in the virtual cart.

3. The system of claim 1, wherein the computer vision monitoring system comprises a customer tracking engine configured to track customer location; wherein the contextual data includes customer location relative to the environment; and wherein the contextual data is used in identification of items during management of the virtual cart.

4. The system of claim 1, wherein the environmental sensing system further comprises a smart shelving system.

5. The system of claim 1, wherein the item entry system is a customer application instance operable on a customer computing device.

6. The system of claim 5, wherein the customer computing device is a smart phone, wherein the customer application instance comprises a manual item entry user interface.

7. The system of claim 5, wherein the customer computing device is a pair of smart glasses that includes a camera; and wherein the customer application is configured to automatically detect item selection events from image data collected from the camera of the smart glasses.

8. The system of claim 1, wherein the item entry system is a smart cart comprising at least one item detection sensor.

9. The system of claim 8, wherein the item detection sensor comprises a camera system; wherein the item selection input is the type of item selection event and item identification data from computer vision processing of image data from the camera system.

10. The system of claim 9, wherein the camera system comprises a first set of internal facing cameras directed inward at an item receptacle of the smart cart and a second set of cameras directed outward.

11. The system of claim 8, wherein the smart cart further comprises at least a second item detection sensor that is a digital scale.

12. A method comprising:
at an environmental sensing system, collecting contextual data on customer activity in an environment;
managing a virtual cart through input from a customer-managed item entry system, the item entry system being movable through an environment, wherein managing the virtual cart comprises:
detecting an item selection event,
identifying an item involved in the selection event, and
updating a virtual cart with the item in accordance with the selection event; and
augmenting management of the virtual cart with the contextual state data

13. The method of claim 12, wherein augmenting management of the virtual cart comprises augmenting the detection of an item selection event.

14. The method of claim 12, wherein augmenting management of the virtual cart comprises augmenting the identification of the item.

15. The method of claim 14, wherein the contextual data includes a set of candidate items in proximity to the customer; and wherein augmenting the identification of the item comprises prioritizing the set of candidate items when identifying the item.

16. The method of claim 12, wherein updating a virtual cart comprises assessing prediction confidence of the virtual cart; and wherein augmenting management of the virtual cart comprises augmenting assessment of the prediction confidence.

17. The method of claim 12, wherein the item entry system is a customer application instance operable on a customer computing platform.

18. The method of claim 17, wherein detecting an item selection event and identifying an item involved in the selection event comprises receiving manual selection of an item through a user interface of the customer application instance.

19. The method of claim 17, wherein detecting an item selection event and identifying an item involved in the selection event comprises collecting image data from a camera of the item entry system and automatically detecting an item selection event and identifying the item from computer vision processing of the image data.

20. The method of claim 12, wherein the item entry system is a smart cart comprising at least one item detection sensor.
